(19) United States
(12) Patent Application Publication
(10) Pub. No.: US 2012/0068368 A1
(43) Pub. Date: Mar. 22, 2012

(54) METHOD FOR MANUFACTURING OPTICAL DIFFRACTION ELEMENT

(75) Inventors: Tatsutoshi Suenaga, Osaka (JP); Yuka Okada, Hyogo (JP); Akiko Murata, Osaka (JP)

(73) Assignee: PANASONIC CORPORATION, Osaka (JP)

(21) Appl. No.: 13/375,672

(22) PCT Filed: Jun. 1, 2010
(86) PCT No.: PCT/JP2010/003656

§ 371 Date: Dec. 1, 2011

(30) Foreign Application Priority Data
Jun. 3, 2009 (JP) 2009-133656

(51) Int. Cl. B29D 11/00

(52) U.S. Cl. 264/1.7

(57) ABSTRACT

If an optical lens base having a diffraction grating on the surface is made of a resin, a corrosion reaction is produced between the optical lens base and a nanocomposite film material, thus deteriorating performance as a diffractive optical element. In the manufacturing process of a diffractive optical element according to the present invention, the nanocomposite film material is dripped onto a die and then heated and dried, thereby vaporizing away a solvent from the nanocomposite film material. After that, the dies are assembled to form a nanocomposite film with a predetermined thickness on the optical lens base. As a result, a diffractive optical element with excellent optical properties can be obtained without producing a reaction between the optical lens base and the nanocomposite film material.

### TECHNICAL FIELD

The present invention relates to a method of making a diffractive optical element and more particularly relates to a method of making a diffractive optical element that realizes excellent optical properties with interactions between materials suppressed.

### BACKGROUND ART

A diffractive optical has a grating structure with a lot of grooves on the surface of a base that is made of some optical material such as glass or resin.

Such diffractive optical elements are used in various optical systems. For example, the diffractive optical element may be used as a lens that is designed to converge diffracted light of a particular order toward a point, or as a spatial low-pass filter, or as a polarization hologram.

With a diffractive optical element, the overall size of the optical system can be reduced, which is one of the advantages achieved by such an optical element.

In addition, contrary to refraction, the longer the wavelength of incoming light, the more significantly the light is diffracted. That is why if a diffractive optical element and a refracting optical element are used in combination, the chromatic aberration and field curvature of the optical system can be reduced, too.

However, in theory, the diffraction efficiency depends on the wavelength of light. Therefore, if a diffractive optical element is designed so as to have its diffraction efficiency optimized responsive to light having a particular wavelength, then its diffraction efficiency will decrease at the other wavelengths.

For example, if a diffractive optical element is applied to an optical system that uses white light (such as a camera lens), that diffractive optical element alone can be used in only a limited number of applications, which is a problem.

Thus, in order to overcome this problem, a phase-type diffractive optical element, which has a diffraction grating at the boundary between two kinds of optical materials, was proposed (see Patent Document No. 1).

In such a phase-type diffractive optical element, a first optical material, which may be a glass or resin base, for example, is coated with a second optical material, which may be a UV curable resin, for example. The coating resin layer functions as an optical adjustment layer. And by choosing two optical materials, of which the optical properties both satisfy particular conditions, the diffraction efficiency at the designed order can always be high irrespective of the wavelength. In this manner, the wavelength dependence of the diffraction efficiency can be reduced.

The diffractive optical element disclosed by Patent Document No. 1 is formed by bonding together a glass lens element, which is made of a glass base, and a resin lens element, which is made of a UV curable resin. And a diffractive optical surface is arranged as the boundary surface where the glass lens element and the resin lens element are bonded together.

Such a diffractive optical element can be produced in the following manner. First of all, a glass base is heated to a temperature that is equal to or higher than a glass transition temperature, and then pressed to a die with diffraction grating grooves, thereby making a glass lens with such diffraction grating grooves on its surface. Next, a predetermined amount of UV-curable resin is dripped onto the glass lens surface with such diffraction grating grooves. Thereafter, while being held with a die that defines the shape of the UV-curable resin, the UV-curable resin is irradiated and cured with UV rays through the glass lens, thereby making the resin lens element. In this manner, a diffractive optical element is completed.

### CITATION LIST

### Patent Literature

Patent Document No. 1: Japanese Patent Application Laid-Open Publication No. 2004-126392

### SUMMARY OF INVENTION

### Technical Problem

As the diffractive optical element disclosed in Patent Document No. 1 uses glass as a lens base, a resin material, of which the optical property fits nicely that of the glass lens base, needs to be chosen as the resin material that coats the surface of the lens base.

If the lens base is made of a resin, however, a corrosion reaction that could occur between the lens base and a resin molded layer (optical adjustment layer) that coats the lens base needs to be taken into consideration. Among other things, the present inventors discovered via experiments that in a manufacturing process in which a liquid material including a resin material yet to be cured and a solvent contacted directly with the lens base, some problem would arise due to a corrosion reaction between those two materials.

In an optical lens in which a diffraction grating has been formed on the surface of a lens base of a resin, the corrosion of the lens base by the material of the optical adjustment layer would deform the diffraction grating itself that has been formed with high precision.

Also, even if no deformation is visually sensible, it is highly probable that the resin component of the optical adjustment layer material should corrode the lens base. The present inventors discovered and confirmed via experiments that as a result of such corrosion, the refractive index of the lens base changed so much that the diffraction property was no longer the designed one.

It is therefore an object of the present invention to provide a method of making a diffractive optical element with excellent optical properties by minimizing such a corrosion reaction between a lens base and the material of an optical adjustment layer even if the lens base is made of a resin.

### Solution to Problem

A method of making a diffractive optical element according to the present invention is designed to make a diffractive optical element that includes a base, which is made of a first optical material including a first resin and which has a diffraction grating on its surface, and an optical adjustment layer, which is made of a second optical material including a second resin and which has been formed on the diffraction grating of the base. The method is characterized by including the steps of: dripping a liquid material, which includes a solvent that decreases the viscosity of the second optical material being dripped and the second optical material as a mixture, onto a die; heating the liquid material that has been dripped onto the die, thereby vaporizing the solvent away and leaving the second optical material on the die; bringing the diffraction grating on the surface of the base into close contact with the second optical material that is left on the die even after the solvent has been vaporized away; curing the second optical material with the diffraction grating kept in close contact with the second optical material, thereby coating the base with the second optical material; and releasing the diffractive optical element, which has been obtained by coating the base with the second optical material, from the die.

In one embodiment, the first optical material is a resin including polycarbonate.

In another embodiment, the second optical material is a composite material including a resin and inorganic particles.

In this particular embodiment, the inorganic particles are mainly composed of at least one oxide that is selected from the group consisting of zirconium oxides, yttrium oxides, lanthanum oxides, hafnium oxides, scandium oxides, alumina and silica.

In still another embodiment, the second optical material has a higher refractive index and a lower dispersion than the first optical material of the base.

In yet another embodiment, the die is made of a metal, glass or resin base material.

### Advantageous Effects of Invention

According to the present invention, by adding a solvent to the second optical material that makes an optical adjustment layer, the viscosity of the second optical material being dripped can be decreased. As a result, the material dripping process can be controlled more easily in terms of its amount and its position.

In addition, according to the present invention, after the liquid material that has been dripped onto a mold has been heated to vaporize the solvent away, the optical lens base and the second optical material are brought into contact with each other, thereby forming an optical adjustment layer. By heating and drying the liquid material in this manner, the solvent included in the material dripped can be vaporized away more efficiently in a shorter time.

On top of that, since the second optical material in gel state that has not cured yet and the optical lens base are in direct contact with each other for a significantly shorter period of time, the interfacial reaction between the optical lens base and the second optical material can be reduced so much that the diffractive optical element can have its refractive index stabilized. What is more, the diffractive optical element can also have its optical properties improved as well.

### BRIEF DESCRIPTION OF DRAWINGS

FIGS. 1(a) through 1(c) illustrate respective manufacturing process steps to make a diffractive optical element according to a preferred embodiment of the present invention.

FIGS. 2(a) through 2(c) illustrate respective manufacturing process steps to make the diffractive optical element of the preferred embodiment of the present invention.

FIG. 3 is a graph showing how the refractive index changes with the drying process condition in a preferred embodiment of the present invention.

FIGS. 4(a) through 4(c) illustrate a die assembly according to a preferred embodiment of the present invention.

FIGS. 5(a) and 5(b) show how the width of a first-order diffracted light ray changes with the heating and drying process condition in a preferred embodiment of the present invention.

FIGS. 6(a) and 6(b) illustrate a diffractive optical element as a preferred embodiment of the present invention.

FIG. 7 shows the diffraction efficiency achieved in a preferred embodiment of the present invention.

FIGS. 8(a) through 8(c) illustrate respective manufacturing process steps to make a diffractive optical element.

FIGS. 9(a) and 9(b) illustrate respective manufacturing process steps to make the diffractive optical element.

### DESCRIPTION OF EMBODIMENTS

Hereinafter, a preferred embodiment of a method of making a diffractive optical element according to the present invention will be described with reference to the accompanying drawings.

First of all, it will be described how to make a diffractive optical element by dripping an optical adjustment layer material on a lens base of a resin.

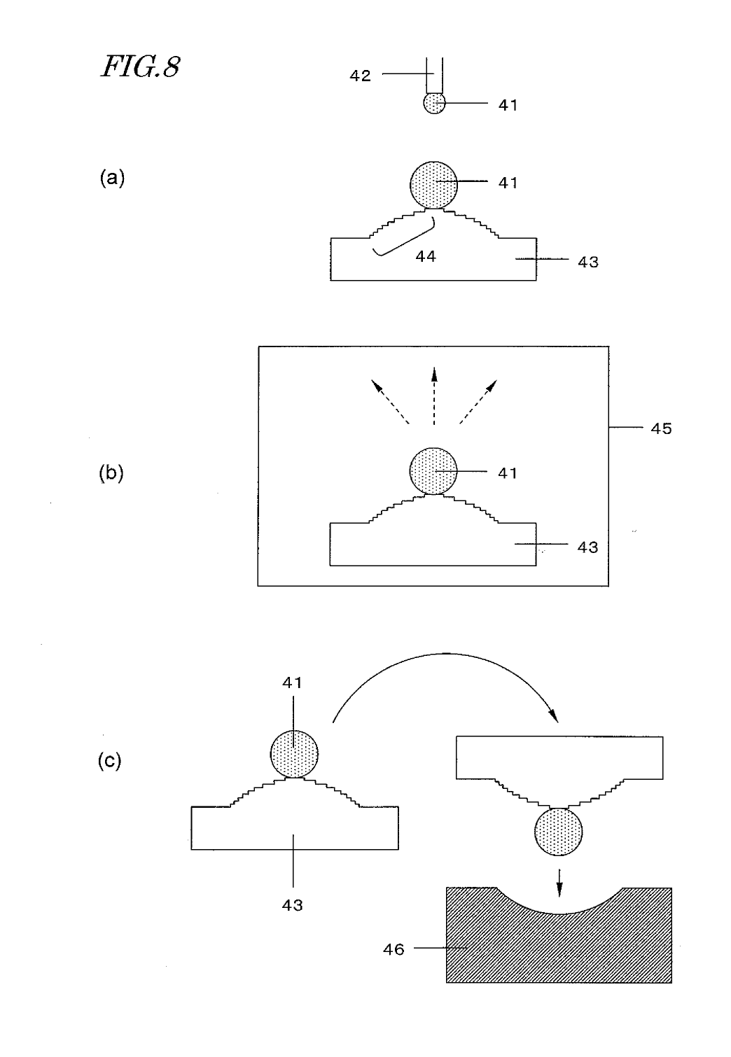

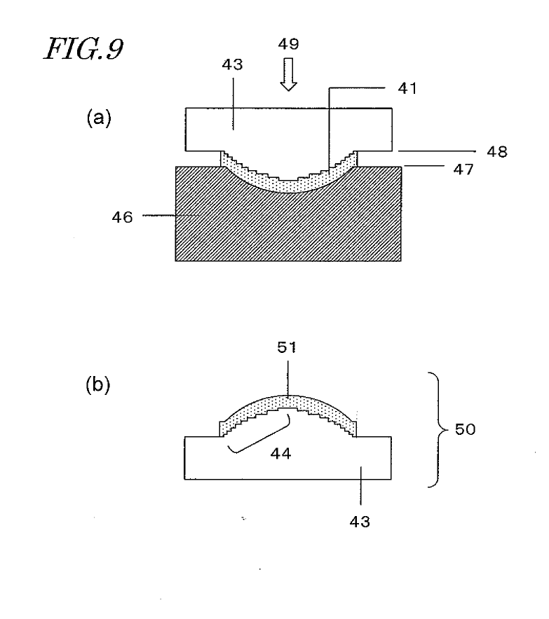

FIGS. 8 and 9 illustrate an example of a method of making a diffractive optical element by using a resin (first optical material) as a material for a lens base (which will be referred to herein as an “optical lens base”) and a UV-curable resin as a material for the optical adjustment layer (which is made of a nanocomposite resin), respectively.

FIG. 8(a) illustrates a dripping process step in which the material of the optical adjustment layer (nanocomposite film) is dripped. In this case, the material to drip is a liquid material (which will be referred to herein as a “nanocomposite film material 41” and) in which a second optical material (including the nanocomposite resin yet to be cured and inorganic particles) and a solvent are mixed together. That is to say, FIG. 8(a) illustrates how to drip the nanocomposite film material 41.

Pressure is applied to the nanocomposite film material 41 in liquid state, which is included in a needle 42, using compressed air or nitrogen, thereby dispensing the nanocomposite film material 41 through the tip of the needle 42 and dripping an appropriate amount of nanocomposite film material 41 onto the diffraction grating surface 44 of an optical lens base 43.

The amount of the material to drip varies according to the size and thickness of the optical lens film to form. In this example, approximately 400 nl of the material was dripped.

FIG. 8(b) illustrates the process step of heating and drying the nanocomposite film material.

In order to vaporize its solvent away from the nanocomposite film material 41 that has been dripped onto the optical lens base 43 (as indicated by the dashed arrows in FIG. 8(b)), the optical lens base 43 is loaded into a device 45 such an oven or a thermostat. In this manner, the solvent is vaporized away from the nanocomposite film material 41.

Nevertheless, although it depends on the difference in solubility parameter between the two materials, even if they are left and dried at nearly room temperature, the nanocomposite film material 41 and the optical lens base 43 may still produce some corrosion reaction at their interface. Since the corrosion reaction is accelerated depending on the process temperature, heating is strictly prohibited in this situation.

For that reason, the nanocomposite film material 41 and the optical lens base 43 are left in an environment at approximately room temperature. However, even if they are dried with the pressure inside of the device 45 reduced, the drying rate is still extremely low and they should be left for long hours. The present inventors discovered via experiments that under this condition, they should be left for approximately six hours (if they were dried at 25° C.) so as to get dried completely.

Next, as shown in FIG. 8(c), a contacting process step (1) is performed by bringing the optical lens base, to which the nanocomposite film material dried has been attached, to a die 46.

Specifically, in this process step, the optical lens base 43 and the nanocomposite film material 41 that have been subjected to the drying process step are turned upside down (as indicated by the arrow in FIG. 8(c)) so as to face the die 46.

Thereafter, as shown in FIG. 9(a), another contacting process step (2) is performed by bringing the optical lens base 43 and the nanocomposite film material 41 into contact with the die 46.

Specifically, the optical lens base 43 is pressed down to a predetermined stop position 48 to the point that a certain gap is left with respect to the die surface 47 and that the nanocomposite film material 41 is spread appropriately.

And with the base 41, film material 43 and die 46 held at these positions, they are irradiated with ultraviolet ray rays through the back surface 49 of the optical lens base 43, thereby curing the nanocomposite film material 41 and forming a nanocomposite film 51 in a predetermined shape.

When the nanocomposite film material 41 is cured, a nanocomposite film 51 with a predetermined thickness gets adhered to the diffraction grating surface 44 of the optical lens base 43 so as to have a curvature that reflects the shape of the die.

After that, by releasing the optical lens base 43 from the die 3, a completed diffractive optical element 50 is obtained as shown in FIG. 9(b).

On the optical lens base 43 for use in the manufacturing process shown in FIGS. 8 and 9, a diffraction grating 44 has been formed highly precisely. However, if an appropriate amount of the nanocomposite film material 41 yet to be cured is dripped onto the surface and then dried, the optical lens base 43 and the nanocomposite film material 41 will cause an interfacial reaction between them, thus deforming the diffraction grating 44 on the optical lens base 43.

Also, even if no deformation is visually sensible, the resin component included in the nanocomposite film material 41 is very likely to corrode the optical lens base 43. As a result, the refractive index of the optical lens base 43 would vary and the diffraction property might be quite different from the designed one. Also, considering the mass productivity, that long time it takes to dry the solvent (e.g., six hours in this example) is an obstacle to the manufacturing takt time.

Thus, a manufacturing process that can minimize such a corrosion reaction between the optical lens base of a resin and the nanocomposite film material and that can be done in a much shorter time will be described.

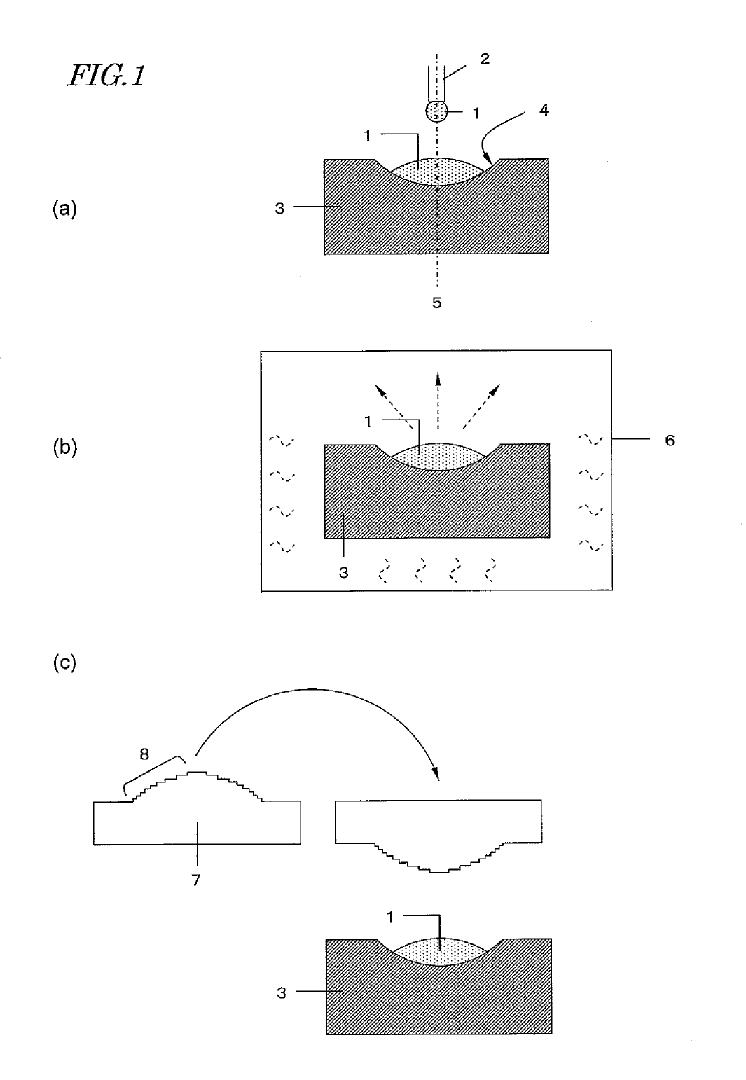

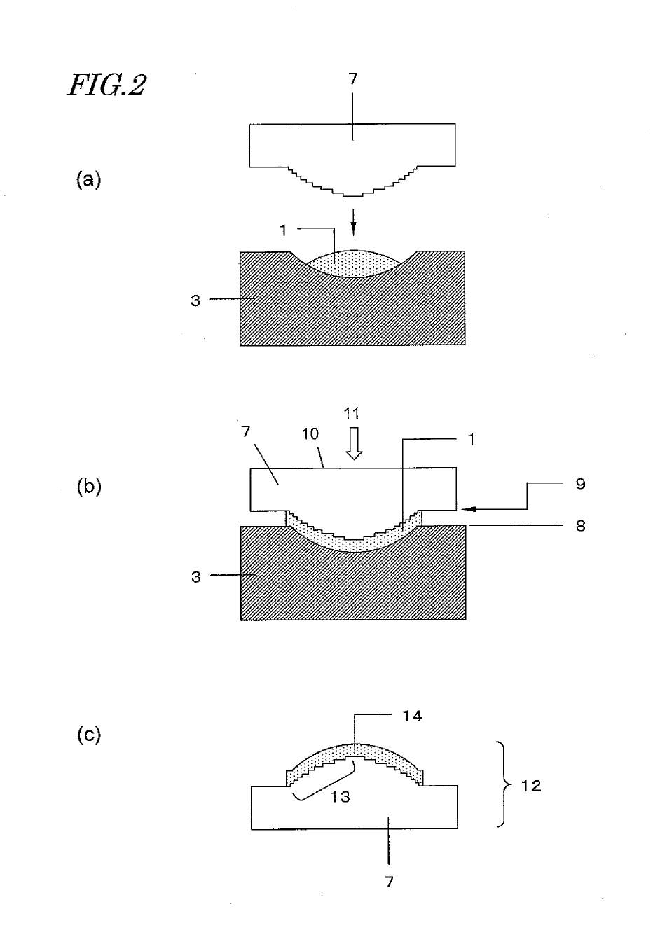

FIGS. 1 and 2 illustrate another manufacturing process for making a diffractive optical element according to a preferred embodiment of the present invention. On the surface of an optical lens base for use in the manufacturing process of this preferred embodiment, a diffraction grating has been formed in a concentric pattern.

Specifically, FIG. 1(a) is a side cross-sectional view illustrating the process step of dripping a nanocomposite film material 1 onto a die 3. FIG. 1(b) illustrates the process step of heating and drying the nanocomposite film material 1 that has been dripped onto the die 3. FIG. 1(c) is a side cross-sectional view illustrating the process step of arranging the die 3 and an objective lens 7 so that they face each other. FIG. 2(a) is a side cross-sectional view illustrating the process step of mounting the optical lens base 7 facedown onto the die. FIG. 2(b) is a side cross-sectional view illustrating a state in which the die 3 and the optical lens base 7 are brought into close contact with each other. And FIG. 2(c) is a side cross-sectional view illustrating a diffractive optical element 12 thus completed.

FIG. 1(a) illustrates the process step of dripping the nanocomposite film material 1, which is a liquid material that is a mixture of a second optical material (including a nanocomposite resin yet to be cured and inorganic particles) and a solvent.

Pressure is applied into a needle 2 using compressed air or nitrogen, for example, thereby dispensing the nanocomposite film material 1 in liquid state through the tip of the needle 2 and dripping an appropriate amount of nanocomposite film material 1 onto a dent 4 of the die 3.

The amount to drip varies according to the size and thickness of the optical lens on which a film needs to be deposited, and therefore, does not have to be a particular amount. The manufacturing process of the diffractive optical element of this preferred embodiment is preferably applied to a small diffractive optical element, of which the lens has a diameter on the order of millimeters (e.g., 2 to 3 mm or less). In such a small diffractive optical element, the amount of the nanocomposite film material to be deposited on its surface is also very small. In this preferred embodiment, approximately 400 nl of the nanocomposite film material 1 is dripped toward the center 5 of the dent of the die 3. According to the size of the lens, the amount to drip could be even smaller, e.g., only about 60 nl.

Also, if the size of the diffractive optical element is that small, it is difficult to coat such a small diffractive optical element with a nanocomposite film by spin coating process. For that reason, according to this preferred embodiment, the nanocomposite film (optical adjustment layer) is formed by pressing the nanocomposite film material 1 with the optical lens base 7 and the die 3.

FIG. 1(b) illustrates the process step of heating and drying the nanocomposite film material 1 on the die 3. The nanocomposite film material 1 that has been dripped onto the 3 is loaded into a heater 6 such as an oven or a thermostat in order to vaporize its solvent away (as indicated by the dashed arrows in FIG. 1(b)), and then heated and dried under a predetermined condition with the temperature and duration of the heating process, and if necessary, the atmosphere controlled. Since the die 3 is made of a metallic material, no corrosion reaction will occur between the die 3 and the nanocomposite film material 1 even when they are heated. And after the solvent is vaporized, a nanocomposite film yet to be cured and inorganic particles will be left there.

Although the die 3 is supposed to be made of a metallic material in this preferred embodiment, the die 3 does not always have to be made of a metal but may also be made of glass as well. Alternatively, the die 3 may even be made of a resin material as long as the resin material does not cause a corrosion reaction with the nanocomposite film material 1.

The nanocomposite film material 1 that has been heated and dried (and that includes the nanocomposite resin yet to be cured and inorganic particles) comes to have a decreased volume and slightly varied appearance as the solvent is vaporized. However, such variations of the material 1 are not shown in detail on the drawings. Also, the solvent will also be described in further detail later. Furthermore, although not shown on the drawings, the nanocomposite film material 1 on the die 3 that has been heated and dried is unloaded from the oven or the thermostat, cooled to room temperature once, and then subjected to the next process step.

The condition of the heating and drying process of this preferred embodiment will be described later after the description of this manufacturing process is finished.

Next, as shown in FIG. 1(c), a contacting process step (1) of bringing the optical lens base 7 into contact with the die 3 is performed.

On the convex surface of the optical lens base 7, a diffraction grating 8 has been formed in a concentric pattern. And by turning that surface of the optical lens base 7 with the diffraction grating 8 upside down (as indicated by the arrow in FIG. 1(c)), the optical lens base 7 is arranged to face the nanocomposite film material 1 and the die 3.

Subsequently, a contacting process step (2) is performed on the optical lens base 7 as shown in FIG. 2(a).

Specifically, in this process step, the optical lens base 7 that has been turned upside down is brought facedown toward the nanocomposite film material 1 and the die 3.

Thereafter, the process step of bringing the optical lens base 7 into close contact with the die 3 is carried out as shown in FIG. 2(b).

The optical lens base 7 is pressed down to a predetermined stop position 9 to the point that a certain gap is left with respect to the die surface 8 and that the nanocomposite film material 1 is spread appropriately. In this description, to bring the optical lens base 7 closer to the die 3 to the point that the nanocomposite film material 1 is pressed and spread by the optical lens base 7 and the die 3 will be referred to herein as “to bring them into close contact with each other”.

With the optical lens base 7 and the die 3 held at these positions, the nanocomposite film material 1 is irradiated with an energy beam 11 (e.g., UV rays according to this preferred embodiment) through the back surface 10 of the optical lens base 7 (i.e., the surface opposite to the surface with the nanocomposite film) so as to be cured.

Although not shown on the drawings, the pressure to be applied to bring them into close contact with each other may be controlled by fastening or loosening screws, for example.

After that, by releasing the optical lens base 7 from the die 3, a completed diffractive optical element 12 is obtained as shown in FIG. 2(c).

In the diffractive optical element 12 thus obtained, a nanocomposite film 14 with a predetermined thickness has been deposited on the surface of the optical lens base 7 with the diffraction grating 13.

Next, the nanocomposite film material 1 to be dripped onto the die 3 in the manufacturing process described above will be described in further detail. The nanocomposite film material 1 is a liquid material in which a nanocomposite resin yet to be cured, inorganic particles and a solvent are mixed together.

The nanocomposite film material 1 for use in the manufacturing process shown in FIGS. 1 and 2 includes a lot of solvent in order to disperse the inorganic particles well enough and to get the dripping process done much more easily. With such a solvent added, it becomes easier to get the inorganic particles dispersed well in the nanocomposite film material. As a result, the transparency of the nanocomposite film increases and the pot life of the nanocomposite film material 1 can be extended.

Also, according to the kind of the resin or additive included in the nanocomposite film material 1, the viscosity of the nanocomposite film material 1 may be too high to drip the nanocomposite film material 1 in a constant amount or to a target position with good stability. Or in a worst-case scenario, the dripping process step may fail completely. Even so, the solvent can contribute to decreasing the viscosity of the nanocomposite film material 1 or controlling dripping the nanocomposite film material 1 more easily (in terms of the amount and position to drip in the dripping process step).

Particularly when a small diffractive optical element, of which the lens has a diameter of a few millimeters (e.g., 2 to 3 mm or less), is produced, the amount to drip becomes on the order of nanoliters. Unlike a normal dripping process step in which a visually sensible amount is dripped, a high-precision control is needed to carry out such a dripping process step on the order of nanoliters. And to perform such a dripping process step, the viscosity of the material should be adjusted appropriately.

However, by adding a solvent to the nanocomposite film material 1, the viscosity can be adjusted more easily. As a result, the dripping process step can get done with good stability and the resin to use can be selected from a wider variety of materials.

It is preferred that a polycarbonate resin, an acrylic resin such as polymethylmethacrylate (PMMA) or an alicyclic acrylic resin, or an alicyclic olefin resin be selected as a material for the optical lens base 7 because these resins have good a light transmitting property. Optionally, in order to increase its moldability or improve its mechanical property, any of these resins may be copolymerized, alloyed or blended with another resin, and may include two or more kinds of resins, not just a single kind of resin. In this preferred embodiment, polycarbonate is used.

Examples of the nanocomposite resins include: (meth)acrylic resins such as polymethylmethacrylate, acrylate, methacrylate, urethane acrylate, epoxy acrylate and polyester acrylate; epoxy resins; oxetane resins; enethiol resins; polyester resins such as polyethylene terephthalate, polyethylene terephthalate, and polycaprolactone; polystyrene resins such as polystyrene; olefin resins such as polypropylene; polyamide resins such as nylon; polyimide resins such as polyimide and polyetherimide; polyvinyl alcohol; butyral resins; vinyl acetate resins; and alicyclic polyolefin resins. In this preferred embodiment, a UV curable acrylate resin is used. Optionally, a mixture or a copolymer of these resins may be used or an organization of these resins may also be used.

The inorganic particles to be included in the nanocomposite film material 1 are preferably composed mainly of at least one oxide that is selected from the group consisting of zirconium oxides, yttrium oxides, lanthanum oxides, hafnium oxides, scandium oxides, alumina and silica. In this preferred embodiment, the inorganic particles are mainly composed of zirconium oxide. Optionally, a composite oxide of these oxides may also be used.

If the optical lens base 7 is made of polycarbonate, the solvent included in the nanocomposite film material 1 may be an alcoholic solvent such as methanol, ethanol, 2-propanol, 1-propanol or 1-butanol, a glycolic solvent such as ethylene glycol or methyl cellosolve, or water. In this preferred embodiment, 2-propanol is used.

Also, the concentration of the 2-propanol is defined by its compounding ratio of 50 wt %.

Nevertheless, the concentration of the 2-propanol does not have to be this value as long as the process step of compounding the nanocomposite film materials and the process step of dripping the nanocomposite film material are affected.

It should be noted that the solvent to be added when the nanocomposite film materials 1 are compounded is an important substance in order to ensure compounding quality and to get the dripping process step done with good stability. However, if the solvent remained in the nanocomposite film formed, then the solvent could change the refractive index of the nanocomposite film or could react with the optical lens base and change the refractive index of the base itself. As a result, the function of the nanocomposite film as an optical adjustment layer would be affected. For that reason, the solvent should be removed almost completely before the film is formed. In this description, “to remove the solvent” means removing the solvent literally completely or removing the solvent almost completely to the level that the solvent should cause no harmful effects.

Thus, in the manufacturing process of this preferred embodiment, the nanocomposite film material 1 is dripped onto the die, and heated and dried as it is, thereby removing (vaporizing) the solvent. In this example, since the die 3 is made of a metallic material, the die 3 and the nanocomposite film material 1 will produce no corrosion reaction even when heated.

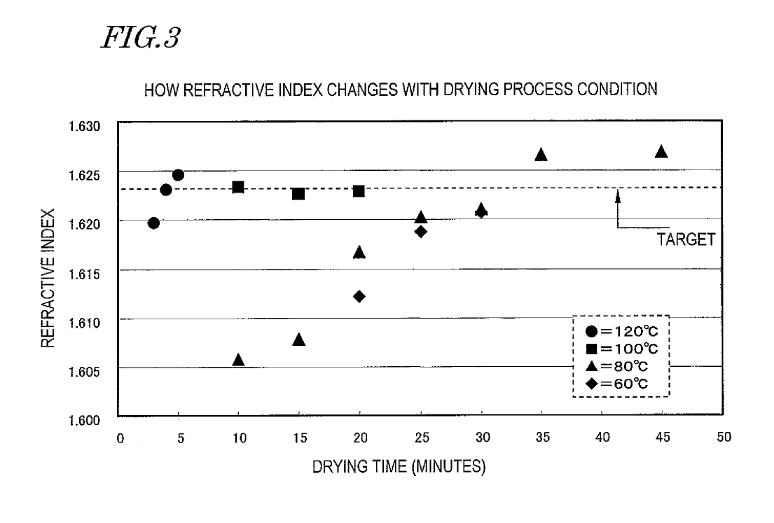

FIG. 3 is a graph showing how the refractive index of the nanocomposite film changes with the heating and drying process condition. The data shown in this graph was relied on in narrowing down the heating and drying process condition.

The refractive index was measured with a prism coupler.

In FIG. 3, the ordinate represents the refractive index of the nanocomposite film and the abscissa represents the drying time.

Also, in this preferred embodiment, the target refractive index of the nanocomposite film was set to be about 1.623 as indicated by the dotted line in FIG. 3.

As for the heating process conditions, since the nanocomposite film material was a resin material, the material was heated to four arbitrarily set temperatures of 60° C., 80° C., 100° C., and 120° C. as shown in FIG. 3, which were set on the supposition that this process would be performed on a resin, thereby plotting a correlation between the heating process temperature and the heating process time.

As a result, the present inventors discovered that there was a strong correlation between the heating process temperature and the heating process time and that the higher the heating process temperature, the shorter the heating process time. The heating and drying process conditions to be derived based on the data shown in FIG. 3 are 30 to 35 minutes for heating process temperatures of 60° C. and 80° C., 10 to 20 minutes for a heating process temperature of 100° C., and 4 to 5 minutes for a heating process temperature of 120° C. In any of these cases, the intended refractive index could be achieved. However, if the process time should be shortened in order to increase the productivity, it is most preferred that the drying process be performed at 120° C. It should be noted that the heating and drying process condition does not have to be this one but may also be any other condition as long as the temperature is equal to or lower than the upper limit temperature, at or under which the resin can be used with no problem.

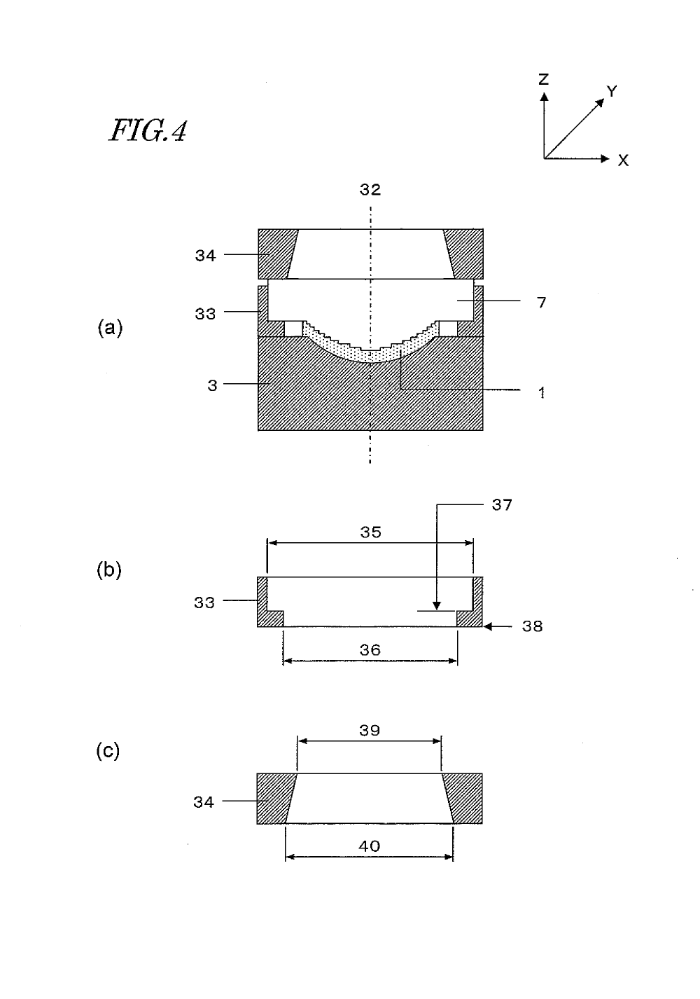

FIG. 4 is a schematic representation illustrating an overall configuration for a die assembly for use in the manufacturing process shown in FIGS. 1 and 2. Hereinafter, it will be described with reference to FIG. 4 how and where the optical lens base 7 should be arranged with respect to the die 3 during the molding process. Specifically, FIG. 4(a) is a side cross-sectional view illustrating a state in which the die 3 and the optical lens base 7 are assembled together during the molding process.

The die assembly includes the die 3 (that has already been described with reference to FIG. 1 and) that determines the shape of the nanocomposite film material 1 deposited on the surface of the optical lens base 7, a regulating mold 33, into which the optical lens base 7 is fitted to regulate its position in the X and Y directions (shown in FIG. 4(a)) and which aligns the center of the die 3 with the center 32 of the optical lens base 7, and an upper mold 34, which prevents the optical lens base 7 from rising in the Z direction (also shown in FIG. 4(a)) and which has the function of pressing the optical lens base 7 onto the die 3.

FIG. 4(b) is a side cross-sectional view illustrating the regulating mold 33, which has two windows 35 and 36 that are opened to face two directions and which also has a stop face 37 that regulates the stop position of the optical lens base 7 during the molding process. The film thickness of the nanocomposite film material 1 is determined by the position of this stop face 37 (and the position of the back surface 38 of the mold shown in FIG. 4(b)).

FIG. 4(c) is a cross-sectional view of the upper mold 34, which is arranged on the upper surface of the regulating mold 33 and which has two windows 39 and 40 to pass a predetermined energy beam through. By using these dies and molds 3, 33 and 34 in combination, a diffractive optical element can be made.

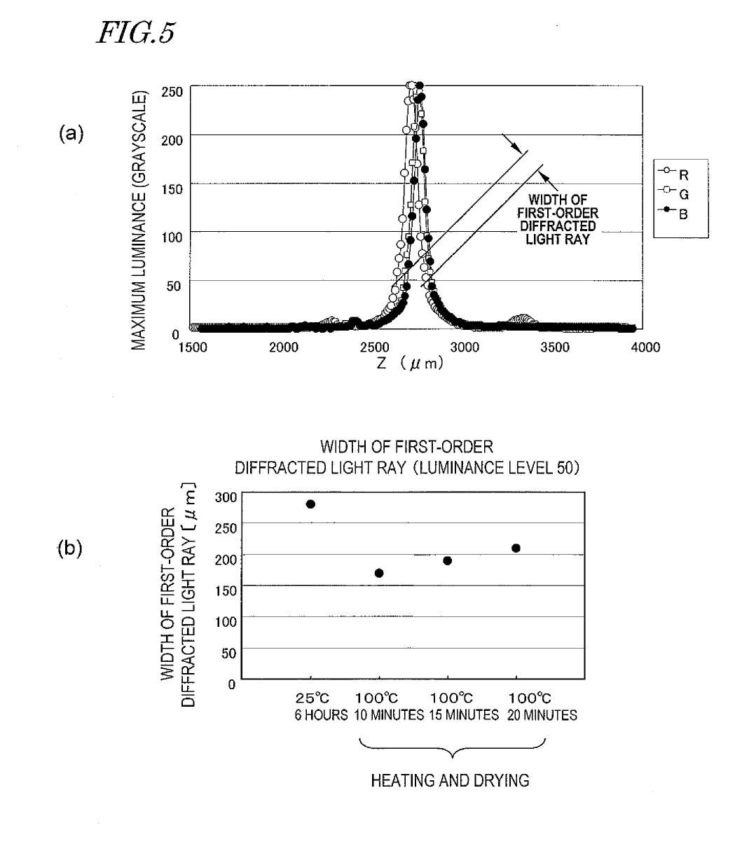

FIG. 5(a) is a graph showing the luminance distributions of first-order diffracted light rays in the optical axis direction in the diffractive optical element that was made by the manufacturing process shown in FIGS. 1 and 2. These luminance distributions were estimated on a ray-by-ray basis with respect to red, green and blue rays with mutually different wavelengths of 640 nm, 550 nm and 495 nm, respectively. In FIG. 5(a), the ordinate represents the maximum luminance, while the abscissa represents the distance as measured from the lens surface in the optical axis direction. These results show the aberration properties of the optical lens. Since the refractive index of the lens medium varies according to the wavelength of the light to transmit, an image is produced at a different position in the depth of focus direction according to the wavelength. In the design process, the smaller the widths of the first-order diffracted light rays with respective wavelengths, the smaller the difference in imaging point between those wavelengths. Also, as for the property of a single-color light ray, if the first-order diffracted light ray has a narrow width, then it means that a greater number of light rays converge toward a single point. Consequently, as far as optical properties are concerned, the narrower the width of the first-order diffracted light ray, the better for the optical system.

The arrows shown in FIG. 5(a) indicate where the width of the first-order diffracted light ray was estimated. This width of the first-order diffracted light ray was obtained by estimating a position where the red ray (with a wavelength of 640 nm) had a maximum luminance of 50 and measuring its size.

FIG. 5(b) shows the width of the first-order diffracted light ray of a diffractive optical element that was subjected to a drying process step at 25° C. for six hours according to the manufacturing process shown in FIGS. 8 and 9 and those of the first-order diffracted light ray of diffractive optical elements, which were made under the three different conditions of this preferred embodiment (i.e., at 100° C. for 10 minutes, at 100° C. for 15 minutes, and at 100° C. for 20 minutes), according to the manufacturing process shown in FIGS. 1 and 2.

As a result, the diffractive optical elements, which were made by being heated and dried under the three different conditions of this preferred embodiment (i.e., at 100° C. for 10 minutes, at 100° C. for 15 minutes, and at 100° C. for 20 minutes), produced a first-order diffracted light ray with a narrower width, and exhibited a better property, than the diffractive optical element that was dried at 25° C. for 6 hours.

The property thus obtained indicates that the diffractive optical element had an excellent chromatic aberration property. In this manner, by vaporizing away the solvent included in the nanocomposite film material before the solvent contacts with the lens base and by shortening the period of time for which the resin yet to be cured contacts with the lens base in the manufacturing process described above, the defect to be caused by the corrosion reaction between the optical lens base and the nanocomposite material can be minimized and a high-performance diffractive optical element can be provided.

As described above, if the base and the nanocomposite film produced an interfacial reaction between them, then the refractive index of the optical lens base would decrease too much to achieve the intended optical property.

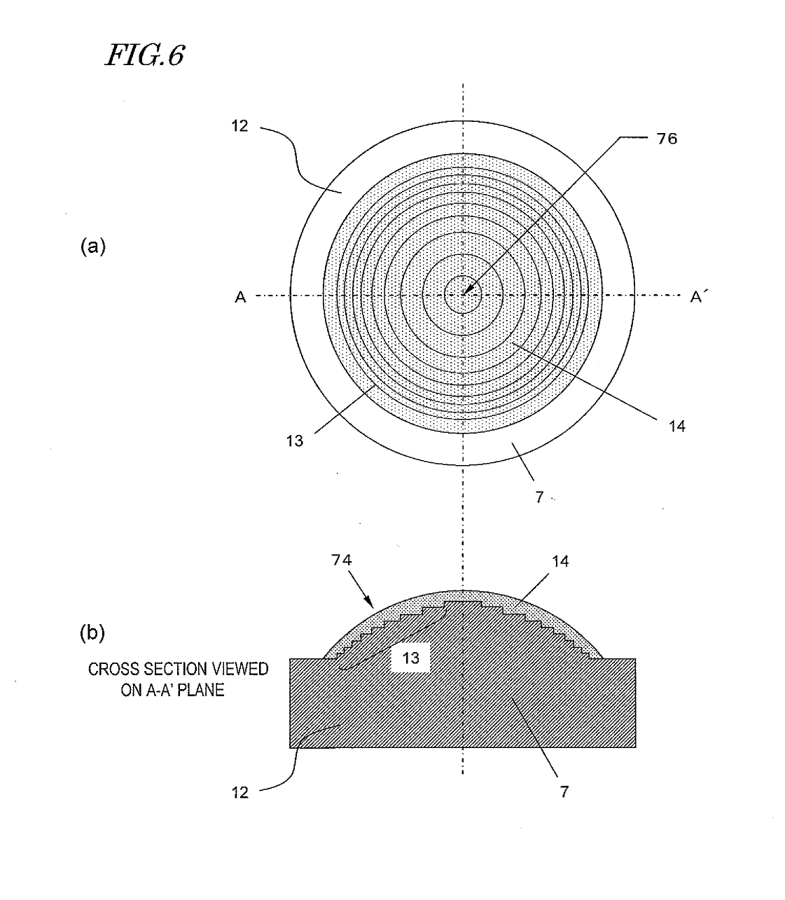

FIG. 6 illustrates a diffractive optical element obtained by the manufacturing process according to the preferred embodiment of the present invention described above. Specifically, FIG. 6(a) is a plan view of the diffractive optical element and FIG. 6(b) is a cross-sectional view thereof as viewed on the plane A-A′ shown in FIG. 6(a). Hereinafter, the diffractive optical element of this preferred embodiment will be further described with reference to FIGS. 6(a) and 6(b).

In the diffractive optical element 12 of this preferred embodiment, a diffraction grating 13 with a concentric pattern, which has been formed on the surface of an optical lens base 7, is entirely covered with an optical adjustment layer, which is made of a second optical material and which has a predetermined curvature 74 (and which will be referred to herein as a “nanocomposite film 14”). The optical lens base 7 with the diffraction grating 13 is made of a first optical material including a first resin. As the first resin, a light-transmitting resin, which is generally used as an optical resin, may be used. Examples of such light-transmitting resins include polycarbonate resins, acrylic resins, alicyclic olefin resins and polystyrene resins.

If the optical adjustment layer 14 is made of the composite to be described later, the optical lens base 7 should have a low Abbe number. That is why it is particularly preferred that the first resin include polycarbonate. Also, the optical lens base 7 with the diffraction grating 13 is generally made by a process such as injection molding. However, the optical lens base 7 does not have to be made by injection molding but may also be made by any other method such as cutting or polishing.

The diffraction grating 13 is formed with respect to the center 76 of the optical lens base 7 and is made up of a number of concentric ring portions, which have a predetermined level difference between them and which have mutually different diameters.

With such an arrangement adopted, the diffractive optical element can be given a lens function. It should be noted that the diffraction grating 13 does not have to have such a concentric pattern as long as the diffraction grating has the diffraction property that is required for the diffractive optical element.

The nanocomposite film 14 may be made of a composite material including a resin and inorganic particles, and is made of a material that has a higher refractive index and a lower dispersion than the optical lens base 7 from the standpoint of the optical property. In that case, the wavelength dependence of the diffraction efficiency can be reduced so much that high diffraction efficiency can be achieved in the entire visible radiation range. The resin that makes the nanocomposite film 14 is preferably either a thermosetting resin or an energy beam (which may be a UV ray or an electron beam) curable resin, considering the dispersion of particles and easiness of handling in the manufacturing process. Examples of such resins include acrylate resins, methacrylate resins, oxetane resins, and enethiol resins. The inorganic particles should have a low dispersion (i.e., a high Abbe number), and therefore, are mainly composed of at least one oxide that is selected from the group consisting of zirconium oxides, yttrium oxides, lanthanum oxides, hafnium oxides, scandium oxides, alumina and silica.

Furthermore, if the diffraction grating 13 is arranged to have such concentric ring portions as shown in FIG. 6, the optical lens base 7 and the nanocomposite film 14 should have their eccentricity controlled so that their centers 76 agree with each other. According to this preferred embodiment, their eccentricity can be controlled highly accurately by the manufacturing process that uses the die assembly described above.

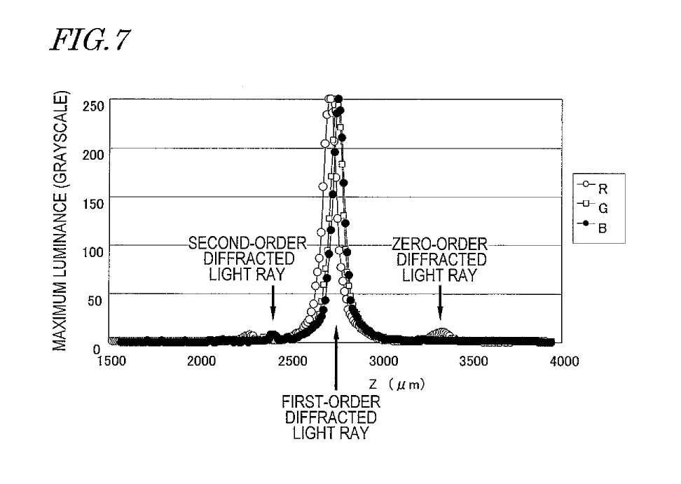

FIG. 7 is a graph showing a result of a diffraction efficiency measurement that was carried out on a diffractive optical element that had been completed by the manufacturing process of this preferred embodiment.

In FIG. 7, the ordinate represents the maximum luminance at each focal point, while the abscissa represents the distance (μm) from the peak of the lens to each focal point. The zero-order diffracted light ray, first-order diffracted light ray and second-order diffracted light ray shown in FIG. 7 were all imaged by the diffractive optical element. In this case, as the zero-order diffracted light ray and second-order diffracted light ray are unnecessary, ideally the zero- and second-order diffracted light rays are as small as possible and the intermediate first-order diffracted light ray rises sharply to get a high grade. Furthermore, if the refractive index of the nanocomposite film 14 is lower than its designed value, the zero-order diffracted light ray increases. On the other hand, if the refractive index of the nanocomposite film 14 is higher than its designed value, then the second-order diffracted light ray increases. Also, if the optical lens base 7 reacts with the nanocomposite film material 1, the low molecular weight components (i.e., the resin yet to be cured or the residual solvent) in the nanocomposite film material 1 will penetrate into the base 7, thereby decreasing the refractive index of the optical lens base 7 and producing the second-order diffracted light ray.

Taking these matters and the results shown in FIG. 7 into consideration, it can be seen that the zero- and second-order diffracted light rays slightly increased just locally but still fell within the permissible range. And the most prominent feature to note is that the first-order diffracted light ray rose steeply.

As can be seen, according to the manufacturing process of the preferred embodiment of the present invention described above, even if the optical lens base having a diffraction grating on its surface is made of a resin, a nanocomposite film (optical adjustment layer) can still be formed on that lens base with good stability.

### INDUSTRIAL APPLICABILITY

The present invention can be used particularly effectively in the field of a diffractive optical element and its manufacturing process. And the diffractive optical element obtained by the present invention may be used in the field of technology of generating a subject's image information, for example.

### REFERENCE SIGNS LIST

1 nanocomposite film material
2 needle
3 die
4 dent
5 center of the dent
6 heater
7 optical lens base
8 diffraction grating
9 stop position
10 back surface
11 energy beam
12 diffractive optical element
13 diffraction grating
14 nanocomposite film
32 center
33 regulating mold
34 upper mold
35 window
36 window
37 stop face
38 mold's back surface
39 window
40 window
41 nanocomposite film material
42 needle
43 optical lens base
44 surface with diffraction grating
45 device
46 die
47 die's surface
48 stop position
49 back surface
50 diffractive optical element
51 nanocomposite film
61 optical resin
62 needle
63 die
64 optical lens
65 convex surface
66 die's surface
67 stop position
68 back surface
69 optical resin film

1. A method of making a diffractive optical element that includes a base, which is made of a first optical material including a first resin and which has a diffraction grating on its surface, and an optical adjustment layer, which is made of a second optical material that is a composite material including a second resin and inorganic particles and which has been formed on the diffraction grating of the base,
the method comprising the steps of:
providing a die that has a molding surface in a predetermined shape;
dripping a liquid material, which includes a solvent that decreases the viscosity of the second optical material being dripped and the second optical material as a mixture, so that the liquid material contacts with a part of the molding surface of the die;
heating the liquid material that still contacts with the part of the molding surface of the die, thereby vaporizing the solvent away and leaving the second optical material on the die;
spreading the second optical material that is left on the die even after the solvent has been vaporized away while bringing the diffraction grating on the surface of the base closer to the molding surface of the die so that the diffraction grating and the molding surface face each other, thereby bringing the second optical material into close contact with the diffraction grating of the base on one side and transferring the predetermined shape of the molding surface onto the other side of the second optical material opposite to the one side that contacts with the diffraction grating;
curing the second optical material with the diffraction grating kept in close contact with the second optical material, thereby coating the base with the second optical material; and
releasing the diffractive optical element, which has been obtained by coating the base with the second optical material, from the die.

2. The method of claim 1, wherein the first optical material is a resin including polycarbonate.

3. (canceled)

4. The method of claim 1, wherein the inorganic particles are mainly composed of at least one oxide that is selected from the group consisting of zirconium oxides, yttrium oxides, lanthanum oxides, hafnium oxides, scandium oxides, alumina and silica.

5. The method of claim 1, wherein the second optical material has a higher refractive index and a lower dispersion than the first optical material of the base.

6. The method of claim 1, wherein the die is made of a metal, glass or resin base material.

7. A method of making a diffractive optical element that includes a base, which is made of a first optical material including a first resin and which has a diffraction grating on its surface, and an optical adjustment layer, which is made of a second optical material including a second resin and which has been formed on the diffraction grating of the base,
the method comprising the steps of:
dripping a liquid material, which includes a solvent that decreases the viscosity of the second optical material being dripped and the second optical material as a mixture, onto a die;
heating the liquid material that has been dripped onto the die, thereby vaporizing the solvent away and leaving the second optical material on the die;
bringing the diffraction grating on the surface of the base into close contact with the second optical material that is left on the die even after the solvent has been vaporized away;
curing the second optical material with the diffraction grating kept in close contact with the second optical material, thereby coating the base with the second optical material; and
releasing the diffractive optical element, which has been obtained by coating the base with the second optical material, from the die.

8. The method of claim 1, wherein the die has a surface that regulates the position of the base along, and perpendicularly to, the center axis of the base.
